(19) United States
(12) Patent Application Publication
(10) Pub. No.: US 2003/0226867 A1
(43) Pub. Date: Dec. 11, 2003

(54) Trailer hitch-mounted transporting device for lawn mowers and landscaping tools

(76) Inventor: Robert Knizner, Copper Canyon, TX (US)

Correspondence Address: Robert Knizner, 913 Meadow Drive, Copper Canyon, TX, 75077, US

(21) Appl. No.: 10/164,482

(22) Filed: Jun. 6, 2002

(51) Int. Cl. B60R 9/00; B60R 11/00

(52) U.S. Cl. 224/521; 224/525

(57) ABSTRACT

The transporting device consists of a trailer hitch receiver adaptor attached near the center of the front cross member. A pair of rails is attached at right angles to the front cross member for each lawn mower to be transported. A front wheel retainer assembly is located in front of each lawn mower, and serves to retain the lawn mower on the transporter. The front wheel retainer assembly has a tension spring that serves to pull the retainer assembly into the open position if a lawnmower is not being retained and into the closed position if a lawn mower is retained. A flat spring located in front of each front lawn mower wheel removes any looseness between the transporting device and the lawn mower, while at the same time helping to hold the front wheel retainer assembly in the closed position.

### FIELD OF THE INVENTION

This invention relates in general to lawn mowers. In particular, the invention relates to a vehicle trailer hitch-mounted transporting device comprising a number of rails and retaining devices to allow the user to transport one or more lawn mowers and landscaping tools.

### BACKGROUND OF THE INVENTION

Without limiting the scope of the invention, its background is described in connection with the transportation of lawn mowers and landscaping tools.

Walk behind lawn mowers are the most popular means of cutting lawn grasses. These lawn mowers are typically powered by gasoline engines and cut a path in the grass about 21 inches wide. Commercial landscape companies utilize these mowers in great numbers, and usually transport them on specially-built trailers. Smaller landscape companies often cannot afford a trailer and transport their mowers in the back of pickup trucks.

In the course of a workday, a landscape crew may load and unload their mowers over 30 times. If they are using a trailer, the trailer's tailgate will usually form a ramp when lowered, allowing the mowers to be loaded and unloaded by pushing them up and down the ramp. Each time the mowers are unloaded, two pins must be removed to allow the ramp to be lowered. The ramp is then lowered by hand. Since the ramps are made of steel, they are very heavy. Often two workers are needed to control the fall of the ramp.

The mowers are held in place on the trailer during transport by straps or ropes. These must be undone in order to move the mowers off of the trailer. Some careless operators do not restrain their mowers during transport. These mowers move around on the trailer and often damage themselves or other equipment being transported.

When the mowing is done, the mowers are pushed back up the ramp on to the trailer, the straps or ropes are re-attached, the heavy ramp is lifted and the two pins replaced.

Landscape companies that transport their mowers in the backs of their trucks have to physically lift the mowers into and out of the truck. These mowers typically weigh about 100 pounds, making this a heavy lift for one person.

A significant percentage of a landscape crew's daily time and effort is expended just loading and unloading the lawn mowers.

As such, a need exists for a relatively inexpensive device to allow landscape crews to easily and quickly load, restrain during transport, and unload lawn mowers without heavy lifting.

### SUMMARY OF THE INVENTION

The present invention provides for a trailer hitch-mounted transporting device for lawn mowers and landscaping tools.

Disclosed in one embodiment is a trailer hitch-mounted transporting device for lawn mowers and landscaping tools.

A typical lawn mower is shown in FIG. 2. The relevant features are the deck that forms the frame of the mower, the front wheels, rear wheels, and the handle.

The transporting device as shown in FIGS. 1, 3, 4, 5, 8, 9, and 11 comprises a front cross member connected to a rear cross member by a plurality of rails at substantially right angles to both the front cross member and the rear cross member. These rails are located such that the space between each pair of their vertical flanges will accommodate the width to the outside of the wheels of the lawn mower. A front wheel retainer assembly is located at the front of each pair of rails. Each front wheel retainer assembly consists of a main shaft on to which the short roller arm and the long roller arm are mounted. The main shaft passes through the holes for main shaft in the lawn mower front wheel stop assembly. The main shaft is free to rotate inside the holes in the lawn mower front wheel stop assembly. The rotation of the main shaft is limited in the upward direction by the short roller arm rotation stop and in the lower direction by the long roller arm rotation stop. The long roller arm rotation stop incorporates the long roller arm stop lock hole. This long roller arm stop lock hole corresponds with the long roller arm lock hole when the long roller arm is at rest on the long roller arm rotation stop.

Each long roller arm and short roller arm has a roller shaft located on its inner surface. Each roller shaft has a roller mounted coaxially on it. The rollers are made of a low friction material and are a loose fit on the roller shafts so that they are free to rotate. Each roller is held onto its roller shaft by a cotter pin, e-clip or similar fastener. The roller shafts are located such that the flat springs are partially deflected by the front wheels when the long roller arm is against the long roller arm rotation stop but not so close to the main shaft that the front wheel is jammed against the main shaft during the downward rotation of the front wheel retainer assembly.

The two outboard roller shafts extend through the long roller arms to form a long roller arm coil spring mount. A front cross member coil spring mount is attached to the front of the two outboard rails. A tension spring stretches between the long roller arm coil spring mount and the front cross member coil spring mount.

The relationship between the front cross member coil spring mount, long roller arm coil spring mount, and the main shaft is critical for the proper operation of the front wheel retainer mechanism. The tension spring must pull the front wheel retainer assembly downward towards the long roller arm rotation stop when the long roller arm is on the long roller arm rotation stop. The tension springs must also pull the front wheel retainer assembly upward when the short roller arm is against the short roller arm rotation stop. The tension spring can satisfy these requirements by being mounted so that as the long roller arm rotates, the long axis of the tension spring moves from one side of the center line of the main shaft to the other.

Each front wheel stop assembly has its upper front flange bent forward to form a front wheel stop assembly flat spring mount. Each front wheel stop assembly flat spring mount has a flat spring bolted onto it. The flat spring consists of one or more flat pieces of spring steel narrower than the lawn mower front wheels and long enough to span the distance between the front wheel stop assembly flat spring mount and the main shaft. The angle of the front wheel stop assembly flat spring mount is such that the flat springs will be deflected by the front wheels when the lawn mower is pushed forward on the rails as the long roller arm and short roller arm rotate downward. The flat springs also serve to push the front wheels against the rollers when the retainer assembly is against the long roller arm rotation stop, reducing any relative motion between the lawn mower 19 and the transporting device.

The holes in the lawn mower front wheel stop assembly are located closer to the rails than is the centerline of the front wheels so that as long roller arm and short roller arm rotate downward, the rollers pass over the center of the front wheels. When the rollers are at the centerline of the front wheels, the flat springs are deflected to their maximum position. As the rollers continue downward past the centerline of the front wheels, the deflection in the flat springs is lessened as the front wheel moves slightly away from the front wheel stop. This over-center action combines with the pull of the tension spring to hold the front wheel retainer assembly against the long roller arm rotation stop, securely retaining the lawn mower on the transporting device.

The lawn mower front wheels are prevented from moving up away from the lower flange of the rails by front wheel vertical restraints. These front wheel vertical restraints are members affixed to each front wheel stop assembly at a substantially right angle to the long axis of the front wheel stop assembly, approximately parallel to its corresponding rail. The distance between the front wheel vertical restraints and the lower flange of the rails is slightly larger than the diameter of the lawn mower front wheel.

The lawn mower rear wheels are prevented from moving up away from the lower flange of the rails by a rear wheel vertical restraint. These rear wheel vertical restraints consist of a member adjacent to each lawn mower's left rail at a substantially right angle to the long axis of both the rear cross member and the left rail, and another member at a substantially right angle to it, approximately parallel to its corresponding rail. The distance between the rear wheel vertical restraints and the lower flange of the rail is slightly larger than the diameter of the lawn mower rear wheel. Only one rear wheel vertical restraint is used per lawn mower, and it is located on the left side of the mower because the designs of most lawn mowers utilize a higher lawn mower deck on the right side that would interfere with a rear wheel vertical restraint on that side.

Each long roller arm has a handle mounted on it to facilitate operation of the retainer assembly without requiring the operator to put his fingers in between any members of the transporting device. These long roller arm handles are D-shaped metal loops affixed to the outside face of the long roller arms near the end farthest away from the main shaft.

Each long roller arm rotation stop has a long roller arm rotation stop lock hole to correspond with a similar long roller arm lock hole. The long roller arm rotation stop lock hole and long roller arm lock hole line up when the long roller arm is against its long roller arm rotation stop, and facilitate the use of a padlock to protect the lawn mower from theft when the operator is away.

Most pickup trucks, sport utility vehicles and some automobiles are equipped with a trailer hitch receiver as shown for reference in FIG. 6. This trailer hitch receiver utilizes an industry-standard configuration to allow a variety of trailer hitches and other accessories to be attached to vehicles so equipped. The most common trailer hitch receivers utilize a hollow square steel tube bolted to the rear frame of the vehicle, with the open end of the tube at the centerline of the vehicle pointing directly to the rear. A trailer hitch or other accessory is inserted into the hollow tube. A hole is drilled at a right angle to the long axis of the hollow tube to facilitate the insertion of a pin to retain the trailer hitch or other accessory.

A hitch adaptor as shown in FIG. 5 connects the transporting device to the trailer hitch receiver. The hitch adaptor consists of a horizontal member and a vertical member joined at substantially right angles to each other. The horizontal member's cross section allows it to slide inside the trailer hitch receiver. This horizontal member has a hole that facilitates the use of a retaining pin through the corresponding hole in the hitch receiver to hold the hitch adaptor in place in the hitch receiver.

The vertical member has a similar cross section to the horizontal member and has a plurality of holes equally spaced along its length.

A pair of flanges is located at the center of the long axis of the front cross member. The distance between these flanges corresponds to the width of the vertical member of the hitch adaptor. A plurality of holes are drilled in the flanges in such a way as to allow a bolt to pass through two or more of the holes as well as the hitch adaptor at the same time, connecting the transporting device and the hitch adaptor. The plurality of holes allows the hitch adaptor to be bolted to the flanges in several configurations, providing a way to alter the height of the transporting device from the ground.

A plurality of auxiliary equipment rack mounts are attached to the front cross member and the rear cross member at substantially right angles to the front cross member and the rear cross member. These auxiliary equipment rack mounts are intended to provide a mounting location for auxiliary equipment transporting racks provided by the end user that are not part of this transporting device. The configuration and location of these auxiliary equipment rack mounts will vary depending on the auxiliary equipment racks to be installed by the end user. FIG. 1 shows one such configuration that has auxiliary equipment rack mounting flanges located such that one auxiliary equipment rack mount is incorporated into a rear wheel vertical restraint and another auxiliary equipment rack mount is located so that strength is gained by its attachment to both the rear cross member and the rail.

FIG. 11 shows user-supplied auxiliary equipment holding racks for string trimmers and an auxiliary equipment holding racks for leaf blowers installed for reference on the transporting device.

The geometry of the transporting device is such that is visually obvious to the user when the lawn mower is securely retained on the transporting device. In any condition other than when the lawn mower is properly retained, the short roller arm will be against the short roller arm rotation stop and the long roller arm will be at an angle to the rails of approximately 45 degrees. When the lawn mower is properly retained, the long roller arm will be substantially parallel to the rails. The action of the tension springs prevents an unsafe in-between condition where the long roller arm is in such a position that the rollers are merely resting on the lawn mower front wheels. In this case, the tension springs will rotate the main shaft so that the short roller arm will be against the short roller arm rotation stop, visually indicating that the lawn mower is not safely retained on the transporting device.

FIGS. 7a and 7b show a lawnmower being placed in the transporting device. In FIG. 7a, the lawn mower is partially in the transporting device, with the lawn mower front wheels resting on the rails. At this point, the front wheel retainer assembly is in its open position with the short roller arm against the short roller arm rotation stop. FIG. 7b shows the lawnmower fully retained on the transporting device. The front wheel retainer assembly is in the closed position, and the long roller arm is against the long roller arm rotation stop. In FIG. 7b, the flat springs are pushing the lawnmower front wheels against the rollers, eliminating any front-to-back motion of the lawn mower on the transporting device.

FIG. 8 shows a detail of the relationship between the lawn mower front wheel and the transporting device when the lawnmower is retained on the transporting device.

### CONCLUSIONS, RAMIFICATIONS, AND SCOPE

Advantages of the transporting device include how easy it is to place a lawn mower into the transporter and how easy it is to remove the lawnmower from the transporter. Other advantages include the positive way that the lawn mowers are retained on the transporter and the visual confirmation to the operator that the lawn mowers are properly retained.

The alternate embodiment could be constructed so as to carry only one mower, not two as shown.

The preferred embodiment could be constructed without the space shown between rails 28b and 28c so as to make it narrow enough to fit compact vehicles.

A box or metal basket could be attached to the transporter between rails 28b and 28c on the preferred embodiment so as to provide a means of carrying incidental items such as gasoline cans, trash bags, etc.

A similar transporting device could be used to transport items other than lawn mowers, such as scooters for the mobility-impaired, golf club carts, and pavement paint striping machines. The retaining device could be mounted on a truck bed or trailer instead of the transporter's front cross member and be used to retain wheeled equipment and vehicles.

### BRIEF DESCRIPTION OF THE DRAWINGS

FIG. 1 is a perspective view of the preferred embodiment of the transporting device.

FIG. 2 is a perspective view of a lawn mower for reference.

FIG. 3 is a detail perspective view of the mower wheel retainer mechanism.

FIG. 4 is an exploded perspective view of the front wheel retainer mechanism.

FIG. 5 is an exploded perspective view of the hitch adaptor.

FIG. 6 is a perspective view of a vehicle trailer hitch receiver for reference

FIGS. 7a and 7b are perspective views of the preferred embodiment of the transporting device in use.

FIG. 8 is a detail view of the preferred embodiment of the transporting device in use.

FIG. 9 is a detail perspective view of a rear mower wheel vertical locator.

FIG. 10 is a perspective view of an alternate embodiment of the transporting device.

FIG. 11 is a perspective view of the preferred embodiment of the transporting device showing auxiliary equipment racks installed for reference.

Reference Numerals Used In Drawings

| | |
|---|---|
| 18 | Transporting device, preferred |
| | embodiment |
| 19 | Lawn mower (for reference) |
| 20a, 20b | Lawn mower rear wheel (for |
| | reference) |
| 21a, 21b | Lawn mower front wheel (for |
| | reference) |
| 22 | Lawn mower deck (for reference) |
| 24 | Lawn mower handle (for reference) |
| 26 | Trailer hitch Receiver (for |
| | reference) |
| 27 | Vehicle rear bumper (for reference) |
| 28a-d | Rails |
| 30 | Trailer hitch adaptor |
| 32a, 32b | Trailer hitch adaptor flanges |
| 34a-d | Holes in trailer hitch adaptor |
| | flanges |
| 36 | |
| 38 | Front cross member |
| 40 | Rear cross member |
| 42a, 42b | Front wheel retainer assembly |
| 44a, 44b | Main shaft |
| 46a, 46b | Short roller arm |
| 48a, 48b | Long roller arm |
| 50a-d | Roller shaft |
| 52a-d | Roller |
| 56 | Vertical member |
| 58 | Horizontal member |
| 60 | Hole in Horizontal member |
| 62a-f | Holes in vertical member |
| 64a, 64b | Tension spring |
| 66a, 66b | Front coil spring mount |
| 68 | |
| 70 | |
| 72 | |
| 74 | Long roller arm coil spring mount |
| 76a,76b | Long roller arm handle |
| 78 | Long roller arm lock hole |
| 80a-d | Front wheel stop assembly |
| 82a-d | Front wheel vertical locator |
| 84a-d | Hole in front wheel stop assembly |
| 85a, 85b | Short roller arm rotation stop |
| 86a, 86b | Rear wheel vertical restraint |
| 88a-d | Front wheel stop assembly flat |
| | spring mount |
| 89 a-d | Front wheel stop assembly flat spring |
| mount hole | |
| 90a-d | Flat spring |
| 92a-d | Flat spring hole |
| 94a, 94b | Long roller arm rotation stop |
| 96a, 96b | Long roller arm rotation stop lock hole |
| 98a-d | Auxiliary equipment holding rack mount |
| 102a, | Auxilinry equipment holding rack for |
| 102b | string trimmers (for reference). |
| 104 | Auxiliary equipment holding rack for |
| | leaf blowers (for reference). |
| 106 | Transporting device, alternate |
| | embodiment, side loading |

### DETAILED DESCRIPTION OF THE PREFERED EMBODIMENTS

The present invention provides for a trailer hitch-mounted transporting device for lawn mowers and landscaping tools.

Disclosed in one embodiment is a trailer hitch-mounted transporting device for lawn mowers and landscaping tools.

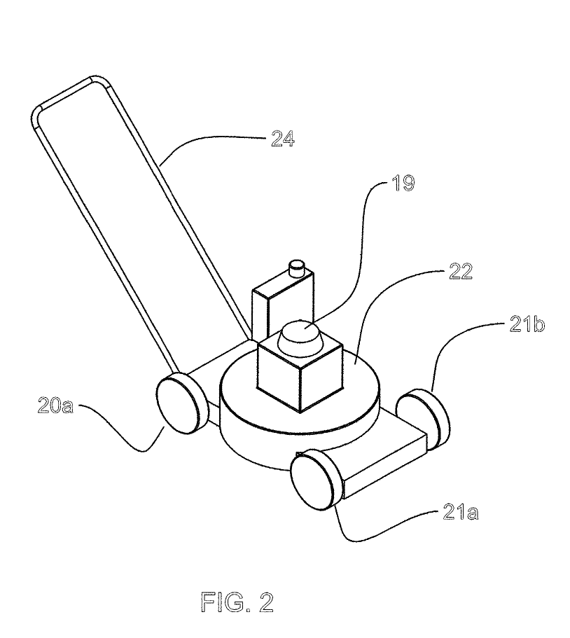

A typical lawn mower 19 is shown in FIG. 2. The relevant features are the deck 22 that forms the frame of the mower, the front wheels 21a and 21b, rear wheels 20a and 20b, and the handle 24.

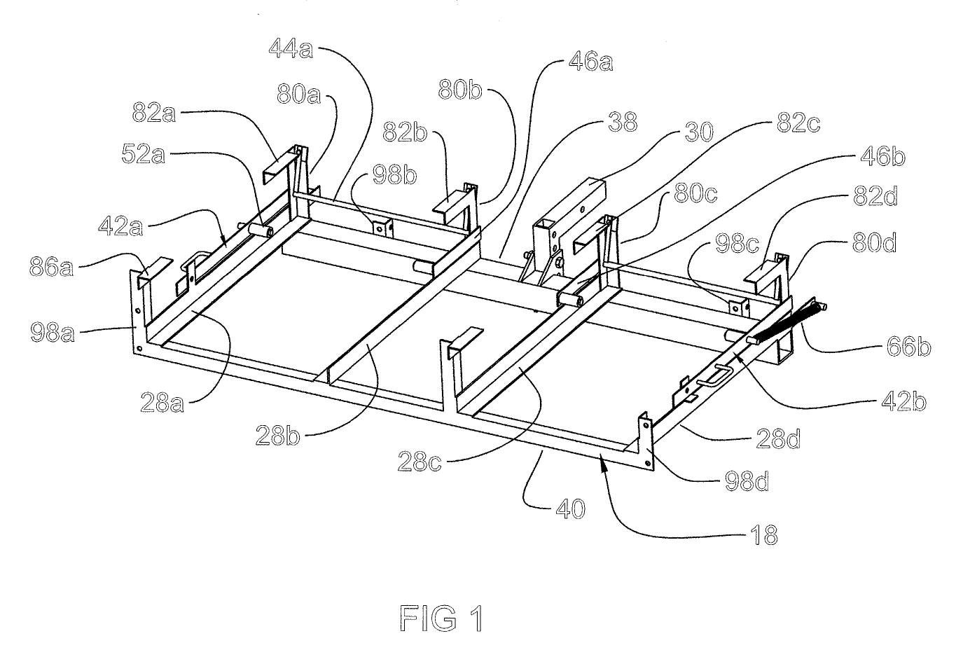

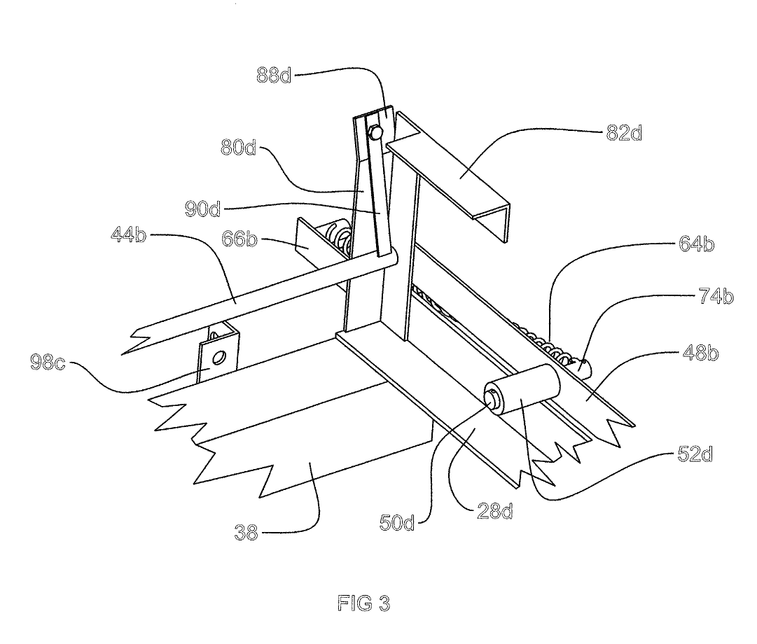

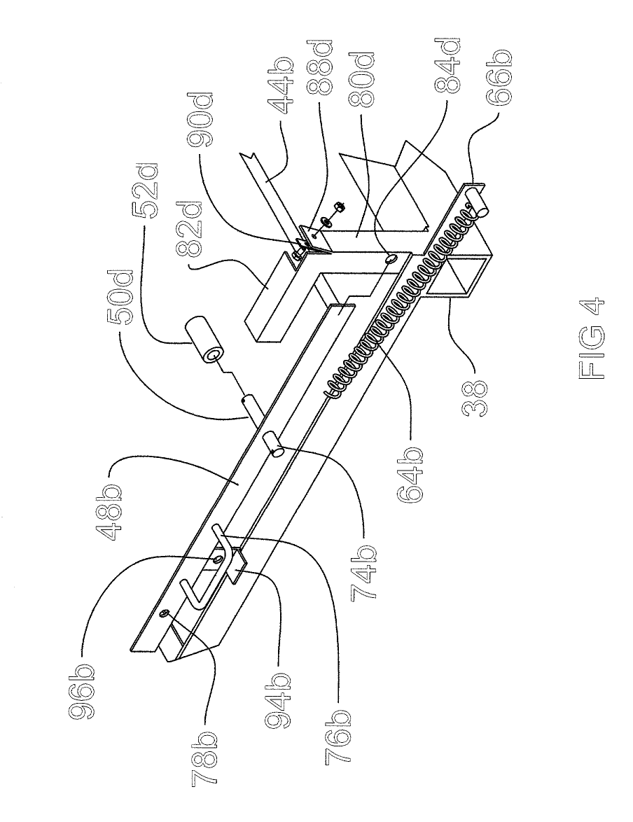

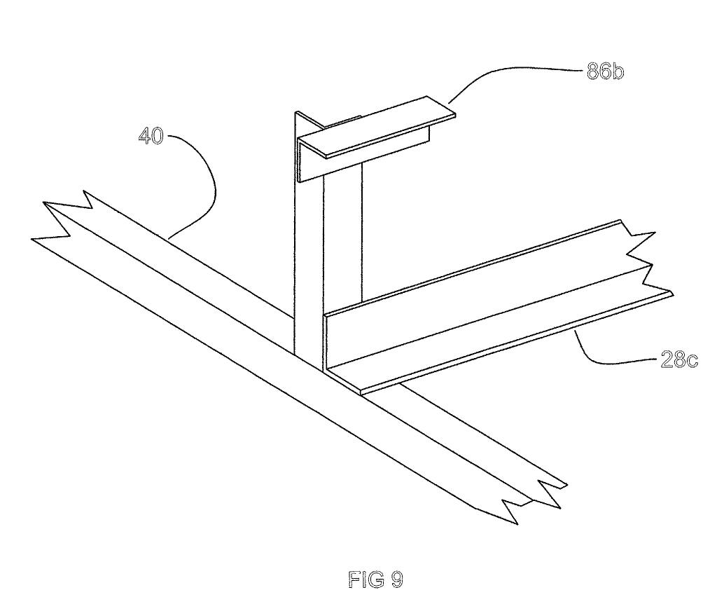

The transporting device 18 as shown in FIGS. 1, 3, 4, 5, 8, 9, and 11 comprises a front cross member 38 connected to a rear cross member 40 by a plurality of rails 28 a-d at substantially right angles to both the front cross member 38 and the rear cross member 40. These rails 28 a-d are located such that the space between each pair of their vertical flanges will accommodate the width to the outside of the wheels of the lawn mower 19. A front wheel retainer assembly 42a, 42b is located at the front of each pair of rails 28 a-d. Each front wheel retainer assembly 42a, 42b consists of a main shaft 44a, 44b on to which the short roller arm 46a, 46b and the long roller arm 48a, 48b are mounted. The main shaft 44a, 44b passes through the holes for main shaft 89a-d in the lawn mower front wheel stop assembly 80a-d. The main shaft 44a, 44b is free to rotate inside the holes in the lawn mower front wheel stop assembly 84a-d. The rotation of the main shaft 44a, 44b is limited in the upward direction by the short roller arm rotation stop 85a, 85b and in the lower direction by the long roller arm rotation stop 94a, 94b. The long roller arm rotation stop 94a, 94b incorporates the long roller arm stop lock hole 96a, 96b. This long roller arm stop lock hole 96a, 94b corresponds with the long roller arm lock hole 78a, 78b when the long roller arm 48a, 48b is at rest on the long roller arm rotation stop 94a, 94b.

Each long roller arm 48a, 48b and short roller arm 46a, 46b has a roller shaft 50a-d located on its inner surface. Each roller shaft 50a-d has a roller 52a-d mounted coaxially on it. The rollers 52a-d are made of a low friction material and are a loose fit on the roller shafts 50a-d so that they are free to rotate. Each roller 52a-d is held onto its roller shaft 50a-d by a cotter pin, e-clip or similar fastener. The roller shafts 50a-d are located such that the flat springs 90a-d are partially deflected by the front wheels 21a, 21b when the long roller arm 48a, 48b is against the long roller arm rotation stop 94a, 94b but not so close to the main shaft 44a, 44b that the front wheel 21a, 21b is jammed against the main shaft 44a, 44b during the downward rotation of the front wheel retainer assembly 42a, 42b.

The two outboard roller shafts 50a-d extend through the long roller arms 48a, 48b to form a long roller arm coil spring mount 74a, 74b. A front cross member coil spring mount 66a, 66b is attached to the front of the two outboard rails 28a-d. A tension spring 64a, 64b stretches between the long roller arm coil spring mount 74a, 74b and the front cross member coil spring mount 66a, 66b.

The relationship between the front cross member coil spring mount 66a, 66b, long roller arm coil spring mount 74a, 74b, and the main shaft 44a, 44b is critical for the proper operation of the front wheel retainer mechanism 42a, 42b. The tension spring 64a, 64b must pull the front wheel retainer assembly 42a, 42b downward towards the long roller arm rotation stop 94a, 94b when the long roller arm 48a, 48b is on the long roller arm rotation stop 94a, 94b. The tension springs 64a, 64b must also pull the front wheel retainer assembly 42a, 42b upward when the short roller arm 46a, 46b is against the short roller arm rotation stop 85a, 85b. The tension spring 64a, 64b can satisfy these requirements by being mounted so that as the long roller arm 48a, 48b rotates, the long axis of the tension spring 64a, 64b moves from one side of the center line of the main shaft 44a, 44b to the other.

Each front wheel stop assembly 80a-d has its upper front flange bent forward to form a front wheel stop assembly flat spring mount 88a-d. Each front wheel stop assembly flat spring mount 88a-d has a flat spring 90a-d bolted onto it. The flat spring 90a-d consists of one or more flat pieces of spring steel narrower than the lawn mower front wheels 21a, 21b and long enough to span the distance between the front wheel stop assembly flat spring mount 88a-d and the main shaft 44a, 44b. The angle of the front wheel stop assembly flat spring mount 88a-d is such that the flat springs 90a-d will be deflected by the front wheels 21 a, 21b when the lawn mower is pushed forward on the rails as the long roller arm 48a, 48b and short roller arm 46a, 46b rotate downward. The flat springs 90 a-d also serve to push the front wheels 21a, 21b against the rollers when the retainer assembly is against the long roller arm rotation stop 94a, b, reducing any relative motion between the lawn mower 19 and the transporting device 18.

The holes in the lawn mower front wheel stop assembly 84a-d are located closer to the rails 28 a-d than is the centerline of the front wheels 21a, 21b so that as long roller arm 48a, 48b and short roller arm 46a, 46b rotate downward, the rollers 52 a-d pass over the center of the front wheels 21a, 21b. When the rollers 52 a-d are at the centerline of the front wheels 21a, 21b, the flat springs 90a-d are deflected to their maximum position. As the roller 52 a-d continues downward past the centerline of the front wheels 21a, 21b, the deflection in the flat springs 90a-d is lessened as the front wheel 21a, 21b moves slightly away from the front wheel stop 80a-d. This over-center action combines with the pull of the tension spring 64a, 64b to hold the front wheel retainer assembly 42a, 42b against the long roller arm rotation stop 94a, 94b, securely retaining the lawn mower 19 on the transporting device 18.

The lawn mower front wheels 21a, 21b are prevented from moving up away from the lower flange of the rails 28 a-d by front wheel vertical restraints 82 a-d. These front wheel vertical restraints 82 a-d are members affixed to each front wheel stop assembly 80 a-d at a substantially right angle to the long axis of the front wheel stop assembly 80 a-d, approximately parallel to its corresponding rail 28 a-d. The distance between the front wheel vertical restraints 86 a-d and the lower flange of the rails 28 a-d is slightly larger than the diameter of the lawn mower front wheel 21a, 21b.

The lawn mower rear wheels 20a, 20b are prevented from moving up away from the lower flange of the rails 28 a-d by a rear wheel vertical restraint 86a, 86b. These rear wheel vertical restraints 86a, 86b consist of a member adjacent to each lawn mower's 21 left rail 28a, 28c at a substantially right angle to the long axis of both the rear cross member 40 and the left rail 28a, 28c, and another member at a substantially right angle to it, approximately parallel to its corresponding rail 28 a-d. The distance between the rear wheel vertical restraints 86a, 86b and the lower flange of the rail 28a, 28c is slightly larger than the diameter of the lawn mower rear wheel 20a, 20b. Only one rear wheel vertical restraint 86a, 86b is used per lawn mower 21, and it is located on the left side of the mower 21 because the designs of most lawn mowers utilize a higher lawn mower deck 22 on the right side that would interfere with a rear wheel vertical restraint 86a, 86b on that side.

Each long roller arm 48a, 48b has a handle 76a, 76b mounted on it to facilitate operation of the retainer assembly without requiring the operator to put his fingers in between any members of the transporting device 18. These long roller arm handles 76a, 76b are D-shaped metal loops affixed to the outside face of the long roller arms 48a, 48b near the end farthest away from the main shaft 44a, 44b.

Each long roller arm rotation stop 94a, 94b has a long roller arm rotation stop lock hole 96a, 96b to correspond with a similar long roller arm lock hole 78a, 78b. The long roller arm rotation stop lock hole 96a, 96b and long roller arm lock hole 78a, 78b line up when the long roller arm 48a, 48b is against its long roller arm rotation stop 94a, 94b, and facilitate the use of a padlock to protect the lawn mower 21 from theft when the operator is away.

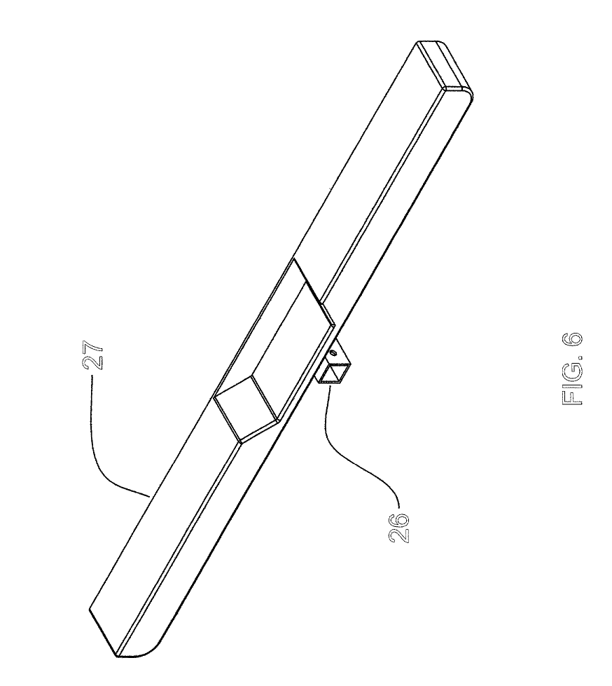

Most pickup trucks, sport utility vehicles and some automobiles are equipped with a trailer hitch receiver as shown for reference in FIG. 6. This trailer hitch receiver utilizes an industry-standard configuration to allow a variety of trailer hitches and other accessories to be attached to vehicles so equipped. The most common trailer hitch receivers utilize a hollow square steel tube bolted to the rear frame of the vehicle, with the open end of the tube at the centerline of the vehicle pointing directly to the rear. A trailer hitch or other accessory is inserted into the hollow tube. A hole is drilled at a right angle to the long axis of the hollow tube to facilitate the insertion of a pin to retain the trailer hitch or other accessory.

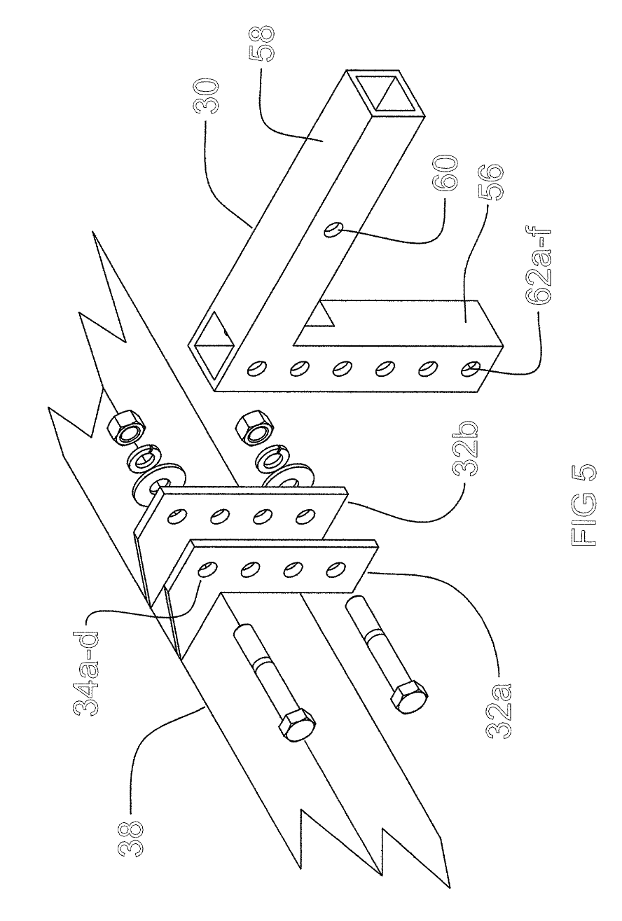

A hitch adaptor 30 as shown in FIG. 5 connects the transporting device 18 to the trailer hitch receiver 26. The hitch adaptor consists of a horizontal member 58 and a vertical member 56 joined at substantially right angles to each other. The horizontal member's 58 cross section allows it to slide inside the trailer hitch receiver 26. This horizontal member 58 has a hole 60 that facilitates the use of a retaining pin through the corresponding hole in the hitch receiver 26 to hold the hitch adaptor 30 in place in the hitch receiver 26.

The vertical member 56 has a similar cross section to the horizontal member 58 and has a plurality of holes 62a-f equally spaced along its length.

A pair of flanges 32a and 32b is located at the center of the long axis of the front cross member 38. The distance between these flanges corresponds to the width of the vertical member 56 of the hitch adaptor 30. A plurality of holes 34a-d are drilled in the flanges 32 a and 32b in such a way as to allow a bolt to pass through two or more of the holes as well as the hitch adaptor 30 at the same time, connecting the transporting device 18 and the hitch adaptor 30. The plurality of holes allows the hitch adaptor 30 to be bolted to the flanges 32a, 32b in several configurations, providing a way to alter the height of the transporting device 18 from the ground.

A plurality of auxiliary equipment rack mounts 98a-98d are attached to the front cross member 38 and the rear cross member 40 at substantially right angles to the front cross member 38 and the rear cross member 40. These auxiliary equipment rack mounts 98a-98d are intended to provide a mounting location for auxiliary equipment transporting racks provided by the end user that are not part of this transporting device 18. The configuration and location of these auxiliary equipment rack mounts 98a-98d will vary depending on the auxiliary equipment racks to be installed by the end user. FIG. 1 shows one such configuration that has auxiliary equipment rack mounting flanges 98a and 98d located such that auxiliary equipment rack mount 98a is incorporated into the rear wheel vertical restraint 86a and auxiliary equipment rack mount 98d is located so that strength is gained by its attachment to both the rear cross member 40 and the rail 28d.

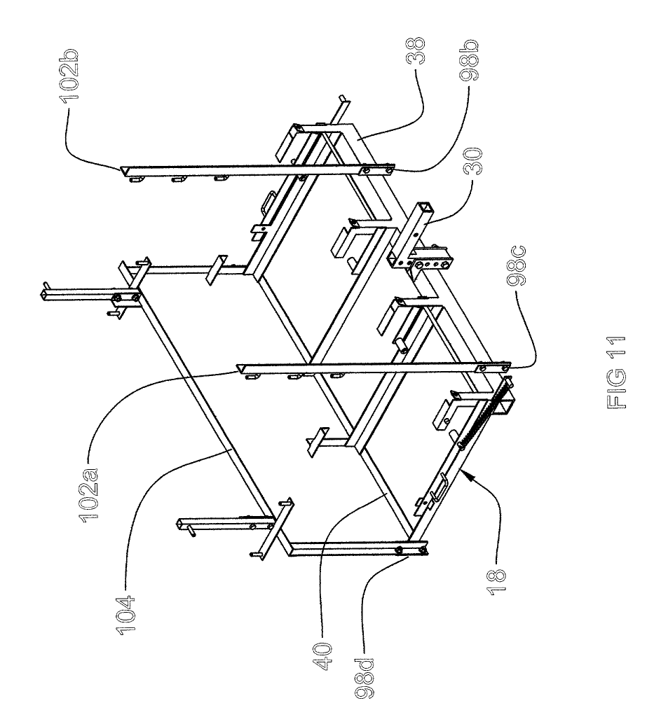

FIG. 11 shows user-supplied auxiliary equipment holding racks for string trimmers 102a, 102b and an auxiliary equipment holding racks for leaf blowers 104 installed for reference on the transporting device 18.

The geometry of the transporting device 18 is such that is visually obvious to the user when the lawn mower 19 is securely retained on the transporting device 18. In any condition other than when the lawn mower 19 is properly retained, the short roller arm 46a, 46b will be against the short roller arm rotation stop 85a, 85b and the long roller arm 48a, 48b will be at an angle to the rails 28a-d of approximately 45 degrees. When the lawn mower19 is properly retained, the long roller arm 48a, 48b will be substantially parallel to the rails 28a-d. The action of the tension springs 64a, 64b prevents an unsafe in-between condition where the long roller arm 48a, 48b is in such a position that the rollers 52a-d are merely resting on the lawn mower front wheels 21a, 21b. In this case, the tension springs 64a, 64b will rotate the main shaft 44a, 44b so that the short roller arm 46a, 46b will be against the short roller arm rotation stop 85a, 85b, visually indicating that the lawn mower 19 is not safely retained on the transporting device 18.

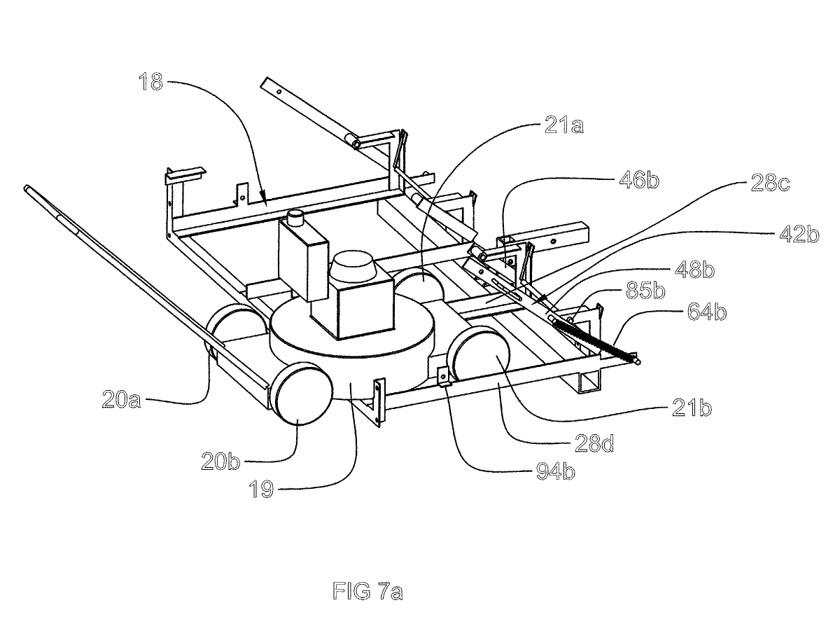

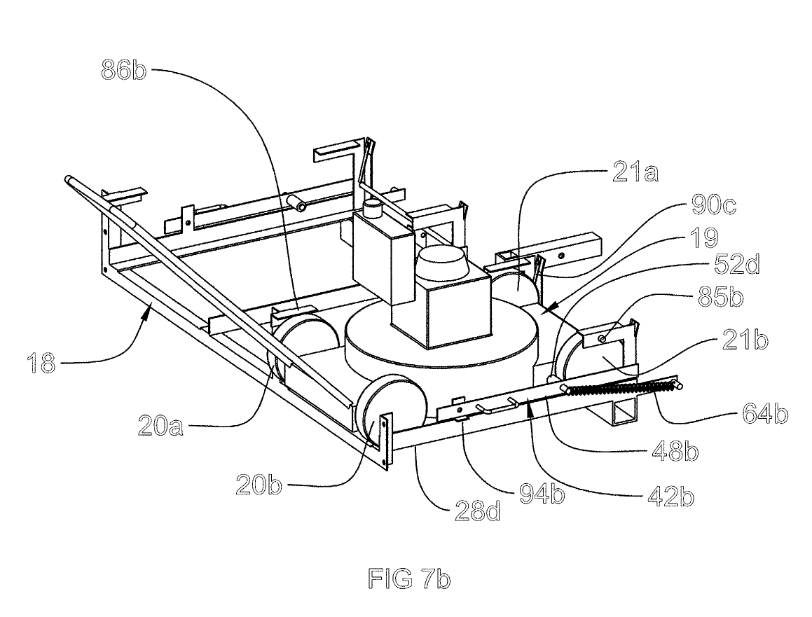

FIGS. 7a and 7b show a lawnmower 19 being placed in the transporting device 18. In FIG. 7a, the lawn mower 19 is partially in the transporting device, with the lawn mower front wheels 21a and 21b resting on the rails 28c and 28d. At this point, the front wheel retainer assembly 42b is in its open position with the short roller arm 46b against the short roller arm rotation stop 85b. FIG. 7b shows the lawnmower 19 fully retained on the transporting device 18. The front wheel retainer assembly 42b is in the closed position, and the long roller arm 48b is against the long roller arm rotation stop 94b. In FIG. 7b, the flat springs 90c and 90d are pushing the lawnmower front wheels 21a, 21b against the rollers 52c and 52d, eliminating any front-to-back motion of the lawn mower 19 on the transporting device 18.

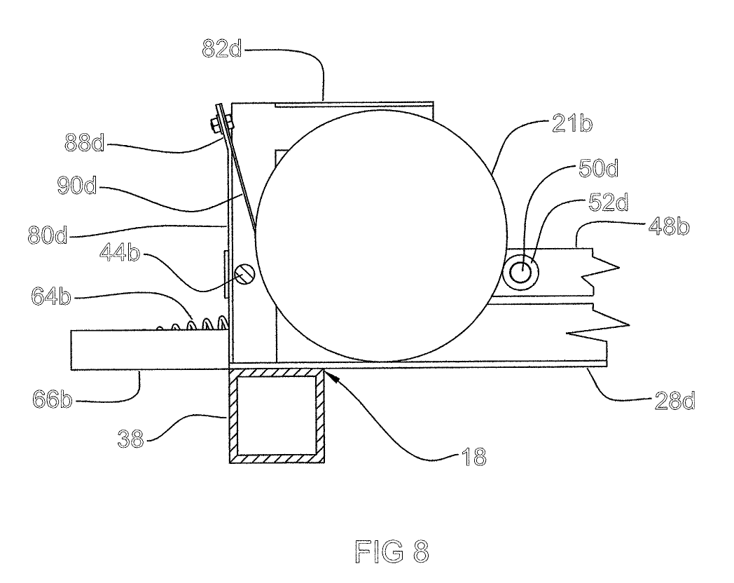

FIG. 8 shows a detail of the relationship between the lawn mower front wheel 21a, 21b and the transporting device 18 when the lawnmower 19 is retained on the transporting device 18.

### DETAILED DESCRIPTION OF ALTERNATE EMBODIMENTS

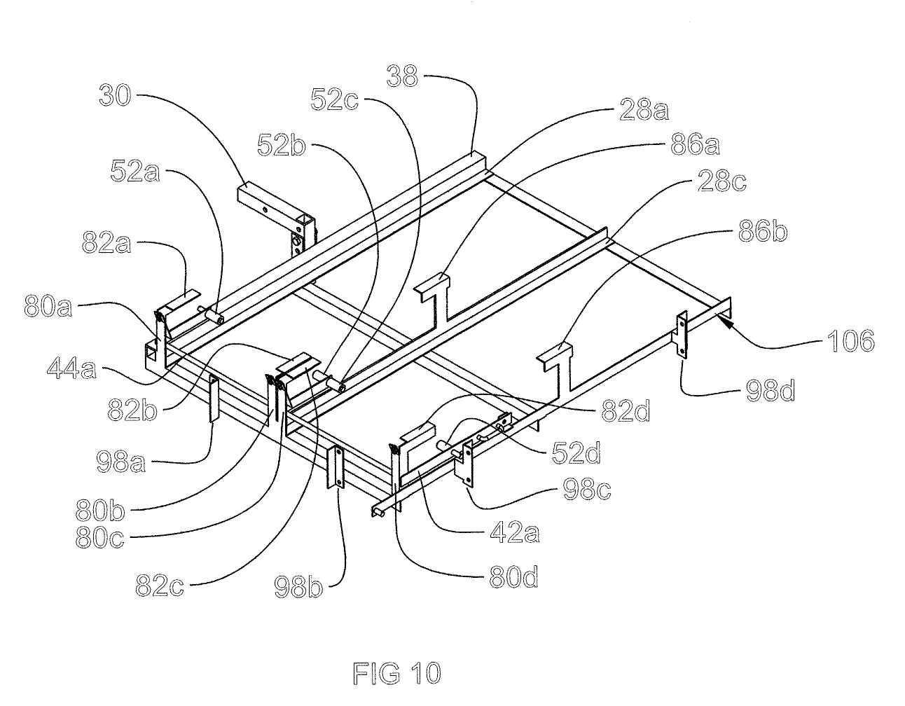

One alternate embodiment is shown in FIG. 10. This alternate embodiment has the rails 28a-d parallel to the front cross member 38. The lawnmower 19 is then loaded and unloaded from the side, rather than from the rear as in the preferred embodiment. This design has an advantage in that the distance from the rear of the vehicle to the rearmost point of the transported equipment is less than that of the preferred embodiment. The torque on the trailer hitch adaptor 30 is increased, however, because the center of gravity of the two mowers is moved to the rear.

I claim:

1. A trailer hitch-mounted transporting device for lawn mowers and landscaping tools, comprising:
(a) a trailer hitch adaptor to allow the device to be connected to a vehicle's trailer hitch receiver, and
(b) rails to support the lawn mower, and
(c) a front cross member to connect the hitch adaptor to the rails, and
(d) a front wheel retainer assembly to secure the mower to the transporting device
whereby the lawn mowers are securely retained on the transporting device and are easily and quickly placed into and out of the transporting device.

2. The transporting device of claim 1 wherein the front wheel retainer assembly provides visual confirmation that the mower is properly retained on the transporting device by returning fully to the open position if the lawn mower is not properly retained.

3. The transporting device of claim 1 wherein the front wheel retainer assembly utilizes the over center effect of a tension spring and a pivoting arm as a means of holding the retainer assembly in both the open and closed positions.

4. The transporting device of claim 1 wherein the front wheel retainer assembly utilizes the over center effect of a roller passing over the centerline of the lawn mower's front wheel to deflect a flat spring as a means to hold the front wheel retainer assembly in the closed position and eliminate relative motion between the mower and the transporting device.

5. The transporting device of claim 1 wherein the trailer hitch adaptor and the trailer hitch adaptor flanges have a plurality of holes as a means to allow the height of the transporting device to be adjusted.

6. The transporting device of claim 1 wherein the rails are parallel to the front cross member.
